(19) United States
(12) Patent Application Publication
(10) Pub. No.: US 2012/0039175 A1
(43) Pub. Date: Feb. 16, 2012

(54) ENABLING A DISTRIBUTED POLICY ARCHITECTURE WITH EXTENDED SON (EXTENDED SELF ORGANIZING NETWORKS)

(75) Inventors: Kamakshi Sridhar, Plano, TX (US); James P. Seymour, North Aurora, IL (US)

(73) Assignee: Alcatel-Lucent USA Inc.

(21) Appl. No.: 12/854,405

(22) Filed: Aug. 11, 2010

(51) Int. Cl. H04W 28/08

(52) U.S. Cl. 370/236

(57) ABSTRACT

When performing load balancing in a wireless extended self-organizing network (extended SON), network health status is monitored by collecting network measurement data and identifying network nodes that require policy adjustment. Based on the network measurement data, network and/or user policies are automatically adjusted and policy updates are disseminated by a policy and charging rule function module to a packet gateway (PGW) as well as to one or more non-PGW network nodes (e.g., base stations, mobility management entity (MME) nodes, radio network controller (RNC) nodes, and the like). The automated policy updates are locally enforced at the nodes that receive the updates, rather than solely at the PGW node.

### BACKGROUND OF THE INVENTION

This invention relates to a method and apparatus for disseminating policy updates to non-gateway nodes in an extended self-organizing network (extended SON) for local enforcement of one or policies, using closed loop feedback in a wireless network.

While the invention is particularly directed to the art of wireless communication, and will be thus described with specific reference thereto, it will be appreciated that the invention may have usefulness in other fields and applications. For example, the invention may be used in non-wireless communication networks, other types of networks, etc.

By way of background, long-term evolution wideband code decision multiple access (LTE/WCDMA) networks currently support a centralized policy infrastructure with the Policy and Charging Rules Function (PCRF) being the entity that stores user and network policies, in compliance with the 3GPP PCC architecture. The 3GPP PCC architecture introduces policies (charging policies, user policies, quality of service (QoS) policies) in the network to help an operator manage the network resources to best serve a particular user. The PCRF determines the policy rules and enforces these policy rules through its interaction with 3GPP Release 7 Policy and Charging Enforcement Function (PCEF), which is located at the packet (data network) gateway (PGW). However, the PCRF does not communicate policy information used for call admission control to the base stations that would allow for dynamic load balancing. As a result, conventional base stations must have their admission control and load balancing policies configured manually, and they cannot modify their call admission control policies and load balancing criteria based on the state of the network (e.g., the type/volume/performance of traffic flowing through the network and congestion in the network).

The present invention contemplates new and improved systems and methods that resolve the above-referenced difficulties and others.

### SUMMARY OF THE INVENTION

A method and apparatus for addressing the problem of dynamic distribution of network policy in wireless systems to enable optimal, near real-time load balancing are provided.

In one aspect of the invention a method of automatically adjusting and locally enforcing policies for network load balancing in a wireless extended self-organizing network (extended SON) comprises collecting network measurement data, determining a network health state by analyzing the collected measurement network data in conjunction with network topology information, and identifying one or more policy updates as a function of the determined network health state. The method further comprises disseminating the one or more policy updates to a packet gateway (PGW) node and at least one non-PGW node in the network, and locally enforcing the one or more policy updates at the PGW node and the at least one non-PGW node to balance network traffic load in the extended SON.

In accordance with another aspect, a system that facilitates automatically adjusting and locally enforcing policies for network load balancing in a wireless extended self-organizing network (extended SON) comprises one or more network measurement tools that collect network measurement data associated with at least one of network congestion and quality of service (QoS), and a policy and charging rules function (PCRF) module. The PCRF module comprises a processor that determines a network health state by analyzing the collected measurement network data in conjunction with network topology information and identifies one or more policy updates as a function of the determined network health state, and a transceiver that disseminates the one or more policy updates to a packet gateway (PGW) node and at least one non-PGW node in the network. The one or more policy updates are locally enforced at the PGW node and the at least one non-PGW node to balance network traffic load in the extended SON.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present innovation exists in the construction, arrangement, and combination of the various parts of the device, and steps of the method, whereby the objects contemplated are attained as hereinafter more fully set forth, specifically pointed out in the claims, and illustrated in the accompanying drawings, where:

FIG. 1 illustrates a long-term evolution (LTE) end-to-end (E2E) network comprising a policy and charging rules function (PCRF) module having a processor, a memory, and a transceiver;

FIG. 2 illustrates a network architecture wherein feedback is collected from or provided by all components in the network (e.g., an LTE network, a CDMA network, a WCDMA network, or the like) and routed to the PCRF module, as indicated by the arrow from the network to the PCRF module;

FIG. 3 illustrates a network architecture that dynamically distributes user policy and network policy information to the eNBs and the MMEs in the network based on sensing and measurement of network conditions that allows the PCRF to communicate customized policy to non-PGW nodes;

FIG. 4 illustrates the PCRF in additional detail, including a plurality of modules stored in the memory and executed by the processor to perform the various functions described herein; and

FIG. 5 illustrates a method of generating automated policy updates for a network for local enforcement at non-PGW network nodes, in accordance with various aspects described herein.

### DETAILED DESCRIPTION

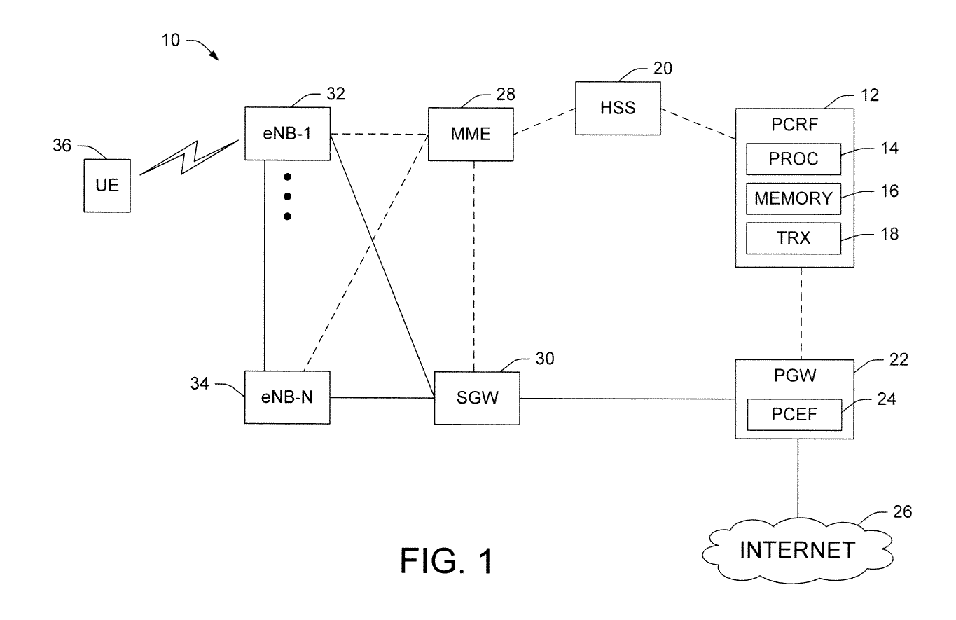

Referring now to the drawings wherein the showings are for purposes of illustrating the exemplary embodiments only and not for purposes of limiting the claimed subject matter. FIG. 1 provides a view of a system into which the presently described embodiments may be incorporated. As shown generally, FIG. 1 illustrates a long-term evolution (LTE) end-to-end (E2E) network 10 comprising a policy and charging rules function (PCRF) module 12 having a processor 14, a memory 16 (i.e., a storage medium), and a transceiver 18. It will be appreciated that although the systems and methods described herein relate to LTE networks employing eNBs, the networks may also be CDMA or WCDMA networks.

“Module,” as used herein, denotes hardware and/or software (e.g., computer executable instructions, routines, programs, algorithms, etc., stored in the memory 16 and executed by the processor 14, or the like) resident thereon for performing the various functions, methods, routines, programs, etc., described herein. “Memory” or “storage medium” may include one or more devices for storing data, including but not limited to read only memory (ROM), random access memory (RAM), magnetic RAM, core memory, magnetic disk storage mediums, optical storage mediums, flash memory devices and/or any other suitable machine-readable media for storing information. One or more of the herein-described embodiments may be implemented by hardware, software, firmware, middleware, microcode, hardware description languages, or any combination thereof, and may be stored in a machine or computer readable medium such as the memory 16, and executed by the processor 14.

The PCRF 12 module is communicatively coupled to a home subscriber server or database 20 that stores policy information for network components and user devices. The PCRF module is also communicatively coupled to a packet gateway (PGW) module 22 that enforces policy decisions made by the PCRF module regarding network traffic control. Enforcement of the policy decisions is carried out by a policy and charging enforcement function (PCEF) module 24 that resides on the PGW module 22. The PGE module 22 is further coupled to a network such as the Internet 26, for communicating information there over.

The HSS module 20 is communicatively coupled to a mobility management entity (MME) module 28, which is the control node for the LTE network 10. The MME 28 is coupled sends control signals (indicated has dashed lines in FIG. 1) to each of a serving gateway (SGW) 30, a first evolved universal mobile telecommunications system terrestrial radio access network (E-UTRAN) node B (eNB) 32, and an Nth eNB 34. Network communication data traffic (indicated by solid lines between nodes in FIG. 1) is communicated between the eNBs 32, 34, the SGW 30, the PGW 22, and the Internet 26. A user equipment (UE) 36 is shown communicating wirelessly with eNB 32. However, it will be appreciated that while FIG. 1 shows one UE and two eNBs, that any number of UEs and eNBs may be coupled to the network 10, and that each UE may communicate with one or more eNBs in accordance with various embodiments. As described herein, a UE denotes a remote user of wireless resources in a wireless communication network and may be referred to herein as a terminal, mobile unit, mobile station, mobile user, access terminal (AT), subscriber, remote station, access terminal, receiver, cell phone, smartphone, laptop, or other communication device, etc.

The MME 28 is responsible for idle mode UE tracking and paging procedure, including retransmissions. It is involved in the bearer activation/deactivation process and is also responsible for choosing a SGW for a UE when the UE initially attaches to the network 10 and at time of intra-LTE handover (e.g., from eBN-1 to another eNB) involving core network node relocation. The MME is also responsible for authenticating the user (e.g., by interacting with the HSS). Non-access stratum (NAS) signaling terminates at the MME, which is also responsible for generation and allocation of temporary identities to UES. The MME checks the authorization of the UE to use the service provider's public land mobile network (PLMN) and enforces UE roaming restrictions. The MME is the termination point in the network for ciphering/integrity protection for NAS signaling and handles security key management. The MME also provides the control plane function for mobility between LTE and 2G/3G access networks with the S3 interface terminating at the MME from a serving GPRS support node SGSN (not shown). The MME also terminates the S6a interface towards the HSS for roaming UEs.

The SGW 30 routes and forwards user data packets received from the EU via an eNB, while acting as a mobility anchor for the user plane during inter-eNB handovers as well as acting as a mobility anchor between the LTE network 10 and other 3GPP technologies (e.g., terminating S4 interface and relaying traffic between 2G/3G systems and the PGW 22). For idle UEs, the SGW 30 terminates the downlink data path and triggers paging when downlink data arrives for the UE. Additionally, the SGW 30 manages and stores UE contexts, including network internal routing information and parameters of the IP bearer service.

The PGW 22 provides connectivity from the UE 36 to external packet data networks (PDNs) by being the point of exit and entry of traffic for the UE 36. The UE 36 may have simultaneous connectivity with more than one PGW for accessing multiple PDNs. The PGW 22 performs policy enforcement (via the PCEF module 24), packet filtering for each user, charging support, lawful Interception and packet screening. Additionally, the PGW serves as an anchor for mobility between 3GPP and non-3GPP technologies such as WiMAX and 3GPP2 (CDMA 1X and EvDO).

The PCRF 12 determines in real-time policy rules for the network 10. In one embodiment, the PCRF is a software component (stored on a computer-readable medium) that operates at the network core and accesses subscriber databases (e.g., stored in the HSS) and other specialized functions, such as a charging system. The PCRF 12 aggregates information to and from the network, operational support systems, and other sources (such as portals) in real time, supporting the creation of rules and automatically making intelligent policy decisions for each subscriber active on the network. This is particularly advantageous where the network provides multiple services, quality of service (QoS) levels, charging rules, etc.

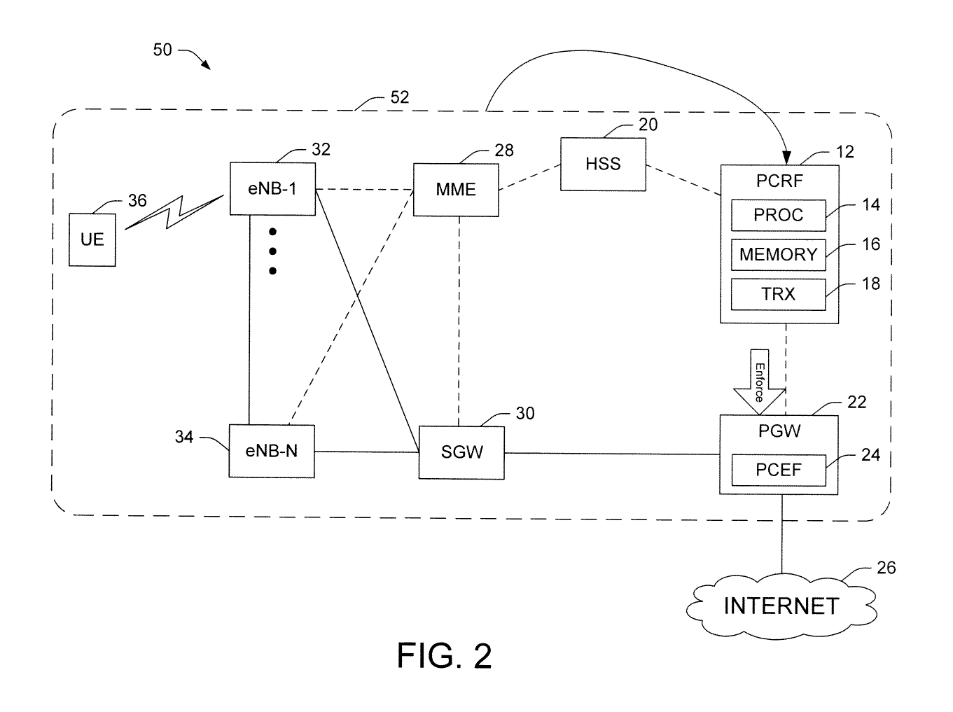

FIG. 2 illustrates a network architecture 50 wherein feedback is collected from or provided by all components in the network 52 (e.g., an LTE network, a CDMA network, a WCDMA network, or the like) and routed to the PCRF module 12, as indicated by the arrow from the network to the PCRF module 12. FIG. 2 thus depicts a closed loop feedback system for network optimization in an extended self-optimizing network (extended SON) 52. The PCRF module 12 comprises the processor 14, memory 16, and transceiver 18, which receives the network feedback. The PCRF module is communicatively coupled to the HSS 20 and the PGW 22, which comprises the PCEF module 24 and is further communicatively coupled to the Internet 26. The HSS 20 is communicatively coupled the MME module 28, which in turn is communicatively coupled to the SGW module 30 and the eNBs 32, 34. The UE 36 is wirelessly coupled to eNB-1 32, and the SGW 30 is further communicatively coupled to the PGE module 22.

FIG. 2 thus depicts a closed loop feedback system for network optimization in an extended self-optimizing network (extended SON) 52. extended SON allows near real-time network measurements to be measured and sent to the PCRF 12, which then decides whether to alter the QoS parameters of one or more data transmission flows. In compliance with the existing 3GPP PCC architecture, this information from the policy decision point (the PCRF) is then communicated to the PGW (the policy enforcement point) which then acts upon the flows going through the network. This allows for near-real time feedback to alter one or more user flows.

Thus, the network 52 is a closed-loop optimized network, where every entity autonomously makes decisions based on policy information. The extended SON network uses monitoring information to help assess the state (e.g., congestion, available bandwidth, quality of service, overall health, etc.) of the network, and communicate it to the PCRF which then distributes the relevant policy information needed for the specific network state conditions to the basestations and MMEs that need that policy input information for call admission control to achieve load balancing. This in turn allows the PCRF to communicate policy information to a subset of eNBs to load balance traffic for specific users from one carrier to another based on a certain network state. In WCDMA, the policy information would be distributed to the RNCs and NBs. In CDMA the policy information would be distributed to the RNCs and basestations.

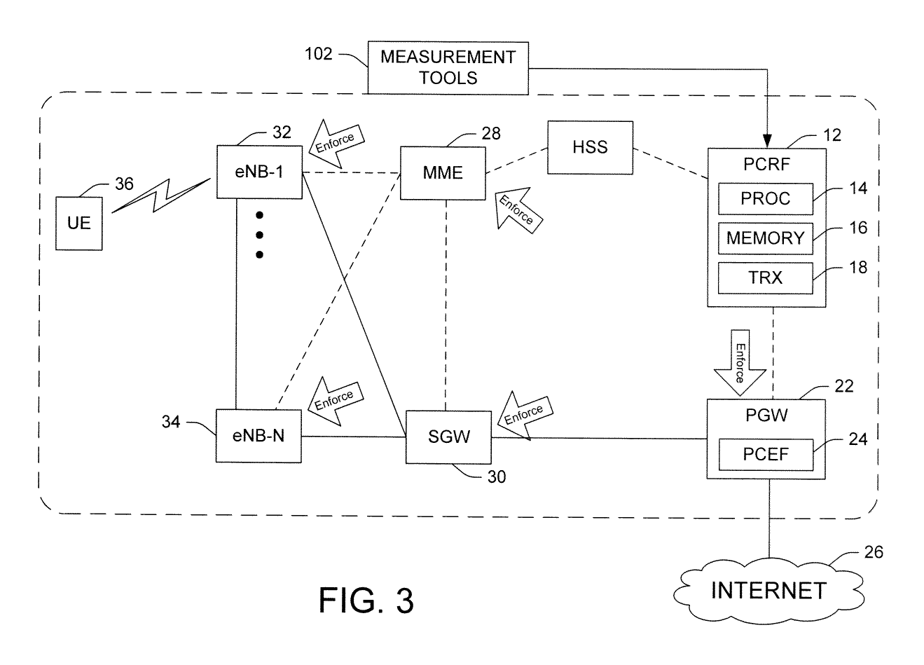

FIG. 3 illustrates a network architecture 100 that dynamically distributes user policy and network policy information to the eNBs and the MMEs in the network (or to the node Bs (NBs), radio network controllers (RNCs) and serving GPRS (general packet radio service) support nodes (SGSNs) in wideband code division multiple access (WCDMA) networks; or to basestations. RNCs and packet data serving nodes (PDSNs) in code division multiple access (CDMA) networks, in accordance with various embodiments) based on sensing and measurement of network conditions that allows the PCRF 12 to communicate customized policy to non-PGW nodes. The network architecture 100 includes the PCRF module 12, which comprises the processor 14, memory 16, and transceiver 18, which receives the network feedback and transmits policy updates to the PGW and other non-PGW nodes in the network (e.g., the MME 28, the SGW 30, the eNBs 32, 34, the UE 36, etc.). The PCRF module 12 is communicatively coupled to the HSS 20 and the PGW 22, which comprises the PCEF module 24 and is further communicatively coupled to the Internet 26. The HSS 20 is communicatively coupled the MME module 28, which in turn is communicatively coupled to the SGW module 30 and the eNBs 32, 34. The UE 36 is wirelessly coupled to eNB-1 32, and the SGW 30 is further communicatively coupled to the PGE module 22.

For optimal load balancing in a communication network, it is desirable that the base stations (eNB. NB, or BTS) and other network elements (e.g., MMEs in LTE. RNCs and SGSNs in a WCDMA network, RNCs and PDSNs in a CDMA network, etc.) be able to dynamically adapt their policies to network conditions in near-real-time. For example, these network elements should be able to set different call admission control policies fora given carrier based on network load and user traffic that are being measured in the network. The architecture 100 provides a mechanism to support dynamic policy distribution for Inter-carrier (within LTE, WCDMA, or CDMA) and/or Inter-RAT (between LTE, WCDMA, and CDMA) load balancing based on user policies, network policies, and network state. These policies include, without limitation, radio channel conditions and resource availability on each carrier, user traffic type (QoS parameters), data rates and mobility information, network loading, etc. The described approach allows traffic to be load-balanced between different carriers to achieve optimal utilization across all carriers for all radio channel conditions and carrier loads.

Thus, the architecture framework 100 dynamically distributes user and network policy update information to the eNBs & MMEs in LTE (shown in FIGS. 1-3), NBs, RNCs and SGSNs in WCDMA networks, and basestations. RNCs and PDSNs in CDMA, based on network-wide sensing of network conditions, which allows the PCRF 12 to communicate customized policy update information and load balancing thresholds to the basestations in near real time. The architecture 100 is extensible to 2G/3G platforms as well as WiFi for optimal load balancing or offloading traffic. LTE/WCDMA networks currently support a centralized policy infrastructure with the PCRF being the entity that stores user and network policy information, in compliance with the 3GPP PCC architecture.

As networks evolve to more complex heterogeneous networks, it is desirable that the basestations have user policy information and a subset of network policy information needed to do call admission control to realize inter-RAT and inter-carrier load balancing based on dynamic load variations coming through. Thus, in the network architecture 100, each node (such as the base station) has a subset of policy information that is disseminated to it in a near-real time manner based on the network conditions. Examples of this policy information include relative handover parameter thresholds, call admission control parameters, etc.

FIG. 3 thus shows an extended SON-based distributed policy architecture as applied to an LTE network, although the principles of extended SON apply to 2G/3G networks as well including WCDMA and CDMA. Near real-time network measurements (e.g., collected via WNG. CelnetXP, etc.) are analyzed by the PCRF 12, combined with persistent network data such as network topology information and subscriber policies, and then used as a trigger to identify and download specific policies (user and network thresholds) from the PCRF to targeted nodes (e.g. eNB). The network measurements collected in real time are used to decide what policy information to send to the various nodes, and when to send it. This allows the basestations to then make optimal load balancing decisions (through intelligent call admission control) across carriers and technologies based on the state of the network.

In one embodiment, the architecture 100 includes end-to-end measurement tools 102, including one or more of a Wireless Network Guardian module (WNG9900), Celnet Xplorer module, a per-call measurement data (PCMD) module, etc., that help collect aggregated data across multiple network elements for near real-time proactive monitoring and data signature analysis. Each of these tools provides different kinds of information on different time scales at different layers of the network.

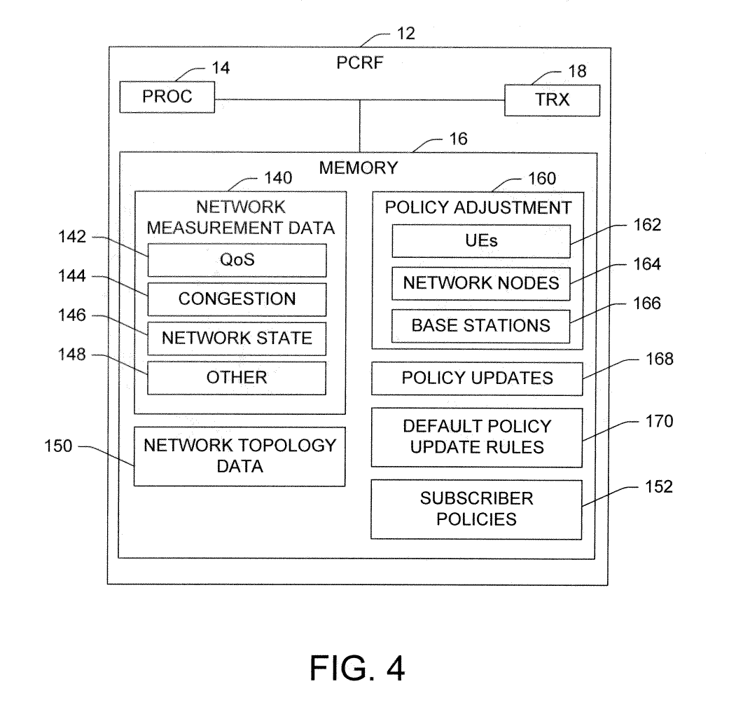

FIG. 4 illustrates the PCRF 12 in additional detail, including a plurality of modules stored in the memory 16 and executed by the processor 14 to perform the various functions described herein. The PCRF 12 receives, via the transceiver 18, network measurement data 140 from one or more of the measurement tools (FIG. 3), which include one or more of the WNG9900 module, Celnet Xplorer module, the PCMD module, etc. Network measurement data 140 is stored in the memory 16 and may include without limitation CtoS information 142 and/or congestion (bandwidth availability) information 144 at one or more network nodes (e.g., the PGW, SGW, HSS, MME, eNBs, and/or UE(s) of the preceding figures, or any other network node that may be present in the network. The measurement data 140 may also include network health or status information 146. Additionally, the network measurement data 140 may include and other network node parameters 148 that may be useful in identifying a state or health of the network at a particular network node or in general.

Network measurement data 140 is combined with network topology information 150 (e.g., node identity, location, etc.) and subscriber policy (e.g., user equipment policy) information 152 to identify potential policy update candidates that will effectively improve network health (e.g., by reducing congestion, etc.) Subscriber or user equipment policies may include, for example, tiered levels of service, whereby UEs subscribing to a highest level of service may receive preferential treatment (e.g., more bandwidth or other resources) than UEs subscribing to lower levels of service.

The memory 16 also stores a policy adjustment module 160 (e.g., a set of computer-executable instructions or the like) that includes policy adjustment instructions for user equipment policies 162, network node policies 164, base station policies 166, and the like.

Examples of user policies may include, without limitation: a policy that assigns low mobility users to certain basestations (e.g., small coverage cells), and assigns high mobility users to certain other basestations (e.g., macro or large coverage cells); a policy that assigns high data rate users to certain basestations (e.g., small cells) or certain Radio Access Technology (RAT), and assigns low data rate users to certain other basestations (e.g., macro cells) or certain other RATS; a policy that sets different thresholds for the above depending on the geographic locations (e.g., metro, rural, etc.), time of day (e.g., rush hour, lunch hour, early morning, etc.); etc.

Examples of QoS policies may include without limitation: a policy for assigning low QoS users (e.g., specific LTE QCIs or WCDMA classes of service, etc.) to certain basestations (e.g. small cells) depending on the radio congestion and transport congestion levels, and assigning high QoS users to certain other basestations (e.g., macro cells); a policy for distributing users with different services and QoS levels across carriers and radio access technologies; etc.

Examples of network policies may include without limitation: a policy for limiting maximum bit rate for best effort users to a predetermined number of Mbps in a given geographic location during certain events, such as sporting events, concerts, or other large gatherings of users; a policy for setting thresholds (e.g., Time To Trigger, Hysteresis values, Qoffset, etc.) to specific values at specific times (e.g., during rush hour traffic, etc.); etc.

Examples of CAC policies may include, without limitation, a policy for changing specific thresholds for admitting a user into a cell. For instance, thresholds for LTE may include: a number of UEs on the eNB and a number of UEs on the cell; a number of bearers on the eNB and number of bearers on the cell; downlink/uplink (DL/UL) PRBs (Physical Resource Blocks) usage on the cell; etc.

“Network state,” as used herein includes the parameters associated with congestion within various links and nodes in the network as measured by packet loss, delay, jitter, and the like.

The processor 14 executes the policy adjustment algorithm(s) 160 and generates policy updates for one or more nodes, which may be the PGW module or a non-PGW node (e.g., the MME. SGW, eNBs, UE(s), etc.) as described with regard to FIGS. 1-3. The transceiver transmits policy update information to one or more of the non-PGW nodes, and optionally to the PGW node, for local enforcement at each network node. Additionally, if the network measurement data 140 indicates that no update is necessary (e.g., bandwidth availability. QoS, etc., are acceptable) at one or more nodes, then no update need be sent to nodes that do not require an update. Default policy update rules 170 may be employed to update only nodes in need of an update (e.g., due to high congestion or the like). In another embodiment, the default policy update rules include a rule to update all nodes periodically, wherein nodes that do not require an update receive policy instructions consistent with a most recent previous policy update in order to maintain the status quo at such nodes.

According to an example, and referring to FIGS. 3 and 4, the UE may be in a high network traffic area, such as a football stadium or the like during a football game. An eNB serving the geographic location of the stadium may be overwhelmed by the number of UEs in its service area, and the network measurement data 140 will indicate to the PCRF module 12 that the eNB is experiencing a high level of congestion. In such a scenario, the processor generates a policy update for the congested eNB to permit voice data and SMS data transmission for its UEs while excluding data services (e.g., internet browsing, streaming data video, etc.) In a related example, where UEs in the congested eNB's service cell subscribe to varied levels of service (e.g., silver, gold, and platinum service packages or the like), the policy update may permit platinum UEs may be permitted to transmit and receive all types of data, while gold US are limited to voice and text data, and silver UEs are permitted to transmit text data only. In any case, the policy update is enforced locally at the congested eNB, rather than only at the PGW module.

In another example, an eNB serving a region through which passes a highway may experience a high level of congestion during rush hour, when UEs passing through the eNBs service sector are moving slowly. Under a conventional approach, an operator would need to manually adjust the network policy for the eNB each day during rush hour. Using the herein-described automated policy update approach with local node enforcement, the processor detects network congestion at the eNB and generates a policy update, and transmits the update to the congested node where it is locally enforced. Once traffic has lessened and the eNB is no longer congested, the processor detects the reduced congestion via the measured network data and transmits a new policy update to the eNB to permit additional resources to be deployed for the UEs in its service sector.

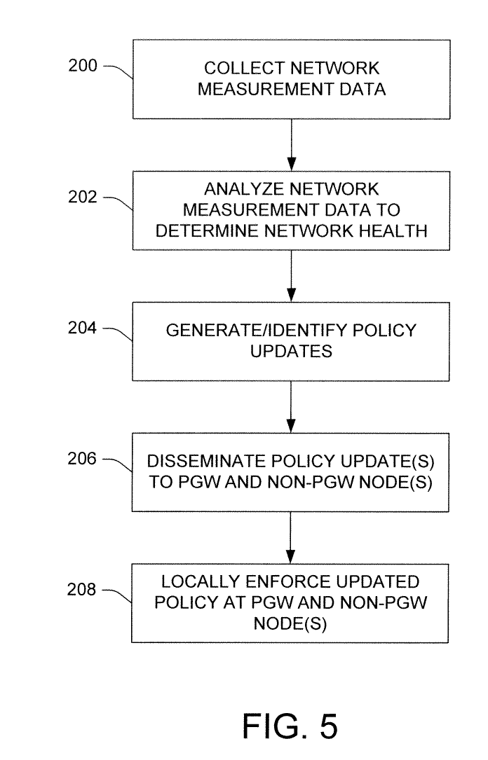

FIG. 5 illustrates a method of generating automated policy updates for a network for local enforcement at non-PGW network nodes, in accordance with various aspects described herein. At 200, network measurement data is collected regarding a status of one or more parameters associated with each node in the network. Parameters may include congestion, bandwidth availability, quality of service, UE mobility (e.g., whether the UEs served by a base station are stationary or mobile), and the like. Network measurement data is collected, for instance, using one or more of a WNG module, Celnet Xplorer module, a PCMD module, or the like. At 202, network measurement data is analyzed to determine network health. At 204, policy updates for UE policies, network policies. QoS policies, and the like are generated (or identified from a lookup table that stores pre-generated policies) in response to network health determinations made during analysis of the network measurement data. At 206, the policy updates are disseminated to a packet gateway (PGW) module and to one or more non-PGW nodes (e.g., MME, SGW, base station, etc.) in the network for local policy enforcement. At 208, the disseminated policies are locally enforced at the PGW and the non-PGW nodes to improve overall network health status.

With regard to the foregoing Figures and related description, it will be appreciated that the functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It will further be appreciated by those skilled in the art that any block diagrams herein represent conceptual views of illustrative circuitry embodying the principles of the described embodiments. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of automatically adjusting and locally enforcing policies for network load balancing in a wireless extended self-organizing network (extended SON), comprising:
collecting network measurement data;
determining a network health state by analyzing the collected measurement network data in conjunction with network topology information;
identifying one or more policy updates as a function of the determined network health state;
disseminating the one or more policy updates to a packet gateway (PGW) node and at least one non-PGW node in the network; and
locally enforcing the one or more policy updates at the PGW node and the at least one non-PGW node to balance network traffic load in the extended SON.

2. The method according to claim 1, wherein the wireless extended SON network is a long term evolution (LTE) network.

3. The method according to claim 2, wherein the at least one non-PGW node is one or more of:
a mobility management entity (MME) module;
a serving gateway (SGW) module; and
an evolved universal mobile telecommunications system terrestrial radio access network (E-UTRAN) node B (eNB).

4. The method according to claim 1, wherein the wireless extended SON network is a wideband code division multiple access (WCDMA) network.

5. The method according to claim 4, wherein the at least one non-PGW node is one or more of:
a radio network controller module;
a serving general packet radio service (GPRS) support node (SGSN) module; and
anode B (NB).

6. The method according to claim 1, wherein the wireless extended SON network is a code division multiple access (CDMA) network.

7. The method according to claim 6, wherein the at least one non-PGW node is one or more of:
a radio network controller module;
a packet data serving node (PDSN) module; and
a node B (NB).

8. The method according to claim 1, wherein the network measurement data is collected by at least one of:
a wireless network guardian (WNG) module;
a Celnet Xplorer module; and
a per-call measurement data (PCMD) module.

9. The method according to claim 1, wherein the at least one policy is a network policy that limits a bit rate for users to a predetermined maximum bit rate in a given geographic location for a given time period

10. The method according to claim 1, wherein the at least one policy is a user policy, wherein the user policy includes at least one of:
a policy that assigns low mobility users to small coverage cells, and assigns a high mobility users to large coverage cells; and
a policy that assigns high data rate users to small coverage cells, and assigns low data rate users to large coverage cells.

11. A processor configured to execute computer-executable instructions, stored on a storage medium, for performing the method according to claim 1.

12. A system that facilitates automatically adjusting and locally enforcing policies for network load balancing in a wireless extended self-organizing network (extended SON), compr)sing:
one or more network measurement tools that collect network measurement data associated with at least one of network congestion and quality of service (QoS);
a policy and charging rules function (PCRF) module comprising:
a processor that:
determines a network health state by analyzing the collected measurement network data in conjunction with network topology information;
identifies one or more policy updates as a function of the determined network health state; and
a transceiver that disseminates the one or more policy updates to a packet gateway (PGW) node and at least one non-PGW node in the network;
wherein the one or more policy updates are locally enforced at the PGW node and the at least one non-PGW node to balance network traffic load in the extended SON.

13. The system according to claim 12, wherein the wireless extended SON network is a long term evolution (LTE) network.

14. The system according to claim 13, wherein the at least one non-PGW node is one or more of:
a mobility management entity (MME) module;
a serving gateway (SGW) module; and
an evolved universal mobile telecommunications system terrestrial radio access network (E-UTRAN) node B (eNB).

15. The system according to claim 12, wherein the wireless extended SON network is a wideband code division multiple access (WCDMA) network.

16. The system according to claim 15, wherein the at least one non-PGW node is one or more of:
a radio network controller module;
a serving general packet radio service (GPRS) support node (SGSN) module; and
a node B (NB).

17. The system according to claim 12, wherein the wireless extended SON network is a code division multiple access (CDMA) network.

18. The system according to claim 17, wherein the at least one non-PGW node is one or more of:
a radio network controller module;
a packet data serving node (PDSN) module; and
a node B (NB).

19. The system according to claim 12, wherein the network measurement data is collected by at least one of:
a wireless network guardian (WNG) module;
a Celnet Xplorer module; and
a per-call measurement data (PCMD) module.

20. The system according to claim 12, wherein the at least one policy is at least one of a network policy and a user policy:
wherein the network policy limits a bit rate for users to a predetermined maximum bit rate in a given geographic location fora given time period; and
wherein the user policy includes at least one of:
a policy that assigns low mobility users to small coverage cells, and assigns a high mobility users to large coverage cells; and
a policy that assigns high data rate users to small coverage cells, and assigns low data rate users to large coverage cells.
